(19) United States
(12) Patent Application Publication
(10) Pub. No.: US 2024/0425026 A1
(43) Pub. Date: Dec. 26, 2024

(54) BRAKE SYSTEM

(71) Applicant: HL MANDO CORPORATION, Pyeongtaek (KR)

(72) Inventor: Jaehoon JANG, Pyeongtaek (KR)

(21) Appl. No.: 18/442,415

(22) Filed: Feb. 15, 2024

(30) Foreign Application Priority Data
Jun. 26, 2023 (KR) 10-2023-0081685

(51) Int. Cl. B60T 13/74; B60T 8/1755; B60T 8/32

(52) U.S. Cl. CPC B60T 13/74; B60T 8/1755; B60T 8/3255

(57) ABSTRACT

The present disclosure relates to a brake system which controls a piston through force control and position control of an electronic actuator to press a disk and provide braking force and is installed in a vehicle to determine whether a failure has occurred and output a safety mode through an indicator when a failure occurs. The brake system comprises a control unit that controls a position of the electronic actuator to provide braking force and compensates the braking force based on a deceleration of the vehicle when the safety mode is output through the indicator.

### CROSS-REFERENCE TO RELATED APPLICATIONS

This application claims benefit and priority to Korean Patent Application No. 10-2023-0081685 filed on Jun. 26, 2023, with the Korean Intellectual Property Office, the disclosure of which is incorporated herein in its entirety by reference.

### TECHNICAL FIELD

The present disclosure relate to a brake system, and more particularly to a brake system that provides braking force and compensates for the braking force through position control of an electronic actuator in a safety mode in response to a failure.

### BACKGROUND

In general, in a brake system, an electronic actuator is controlled to adjust the extension/contraction of a piston to press a disk and generate braking force.

In other words, an electric brake system controls an electronic actuator to create braking force.

The electronic actuator controls the force of the piston pressing a pad or disk through force control, which is detected by a separate sensor, or controls the force applied to the pad or disk.

In addition, a control unit may notify a driver through a safety mode that a situation requiring inspection has occurred when the control state is unreliable due to a problem with the force sensor or an error in the force control of the control unit.

In this safety mode, when the electronic actuator is controlled through force control, problems arise in providing the braking force required by the driver or in the reliability of the provided braking force.

That is, in the safety mode, there is a problem with the electronic actuator providing the braking force required by the driver through force control.

For example, the brake system may generate excessive braking force or insufficient braking force contrary to the driver's needs as described above, which increases the risk of an accident.

Accordingly, even in the safety mode, the brake system needs to stably control the electronic actuator to form braking force that meets the driver's needs.

### SUMMARY

Embodiments of the present disclosure provide a brake system including an electronic actuator capable of providing braking force and compensating for the braking force through position control even in a safety mode when a failure occurs.

A brake system, in accordance with an embodiment of the present disclosure, which controls a piston through force control and position control of an electronic actuator to press a disk and provide braking force and is installed in a vehicle to determine whether a failure has occurred and output a safety mode through an indicator when a failure occurs, comprises: a control unit that controls a position of the electronic actuator to provide braking force and compensates the braking force based on a deceleration of the vehicle when the safety mode is output through the indicator.

Further, the control unit may calculate target deceleration based on information of a brake pedal.

Further, a deceleration map for controlling the electronic actuator to output a braking force corresponding to the calculated target deceleration may be pre-stored in the control unit.

Further, the control unit may control a position of the piston through the electronic actuator based on the deceleration map.

Further, the control unit may calculate a current deceleration of the vehicle according to the controlled electronic actuator.

Alternatively, the control unit may compensate for braking force by readjusting the position of the piston through the electronic actuator based on the calculated current deceleration information of the vehicle.

Further, the brake system may further comprise a position detection unit that transmits position information of the electronic actuator to the control unit.

Further, the control unit may control only the position control of the electronic actuator to adjust the braking force when the safety mode is output through the indicator.

Further, the brake system may further comprise: an acceleration sensor for detecting a longitudinal acceleration of the vehicle and transmits the detected longitudinal acceleration to the control unit.

A brake system, accordance with another embodiment of the present disclosure, which controls a piston through force control and position control of an electronic actuator to press a disk and provide braking force, and is installed in a vehicle to operate in a safety mode when a failure occurs for force control of the electronic actuator, comprises: an indicator that outputs the safe mode; a brake pedal that transmits a driver's intention to brake; and a control unit that compensates for the braking force by controlling the position of the electronic actuator based on information of the brake pedal when the safety mode is output through the indicator.

Further, the control unit may calculate target deceleration based on the information of the brake pedal and a speed of the vehicle.

Alternatively, the control unit may control the electronic actuator based on position information of the electronic actuator preset according to target deceleration information.

Alternatively, the control unit may control the electronic actuator based on position information of the piston preset according to target deceleration information.

Alternatively, the control unit may control the electronic actuator based on position information of a pad preset according to target deceleration information.

Alternatively, a deceleration map for controlling the electronic actuator to output a braking force corresponding to the target deceleration information may be pre-stored in the control unit.

Further, the control unit may control the electronic actuator based on the deceleration map and then calculates a current deceleration of the vehicle.

Further, the control unit may compare the current deceleration of the vehicle with the calculated target deceleration to determine whether compensation for the braking force is needed.

Further, the control unit may control the electronic actuator to compensate for the braking force when the current deceleration of the vehicle is different from the calculated target deceleration.

Further, the electronic actuator may include a motor of which rotation is controlled by the control unit.

Further, the control unit may calculate the current deceleration of the vehicle based on any one of an acceleration sensor that detects a longitudinal acceleration of the vehicle, current speed information of the vehicle, or information about wheels of the vehicle.

According to the embodiments of the present disclosure, the brake system can provide braking force and compensate for the braking force through position control in the event of a failure of the electronic actuator, thereby enabling the vehicle to be driven stably to a service center where the vehicle can be inspected.

### BRIEF DESCRIPTION OF THE DRAWINGS

FIG. 1 shows a configuration diagram of a brake system according to one embodiment of the present disclosure.

FIG. 2 shows a compensation process of the brake system according to one embodiment of the present disclosure.

FIG. 3 shows the operating sequence of the brake system according to one embodiment of the present disclosure.

### DETAILED DESCRIPTION

Hereinafter, with reference to the accompanying drawings, embodiments of the present disclosure will be described in detail so that those skilled in the art can easily implement the present disclosure. The present disclosure may be implemented in many different forms and is not limited to the embodiments described herein.

It should be noted that the drawings are schematic and not drawn to scale. The relative dimensions and proportions of parts in the drawings are shown exaggerated or reduced in size for clarity and convenience in the drawings, and any dimensions are illustrative only and not definitive. In addition, the same reference symbols are used for the same structural elements or parts appearing on two or more drawings to indicate similar features.

The embodiments of the present disclosure specifically represent ideal embodiments of the present disclosure. As a result, various variations of the diagram are expected. Accordingly, the embodiment is not limited to the specific shape of the illustrated area and also includes changes in shape due to manufacturing, for example.

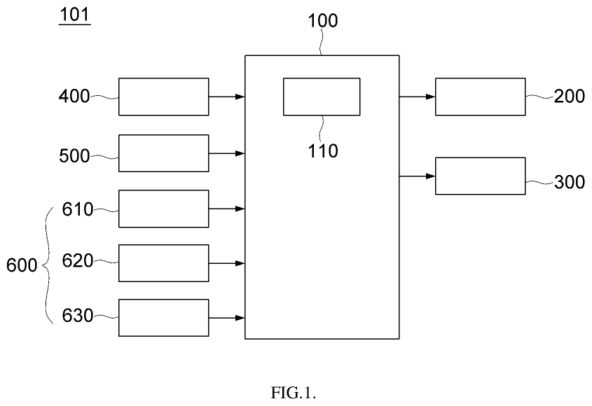

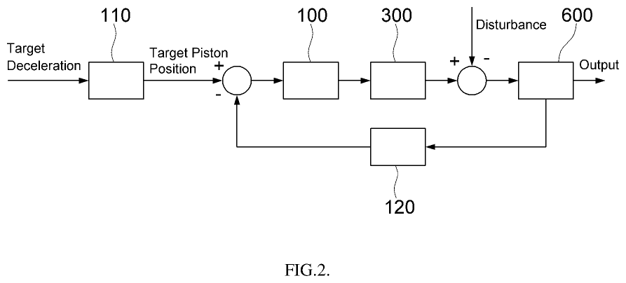

Hereinafter, with reference to FIGS. 1 and 2, a brake system 101 according to one embodiment of the present disclosure will be described.

The brake system 101 of the present disclosure is installed in a vehicle. In addition, the brake system 101 includes an electronic actuator 300. Specifically, the electronic actuator 300 controls the piston to press a disk to provide braking force.

In addition, the electronic actuator 300 is force controlled and position controlled. The electronic actuator 300 may control braking force through force control by pressing the disc. Specifically, the electronic actuator 300 controls the piston, and the operation of the electronic actuator 300 is controlled based on the force of contact between the pad and the disk.

Alternatively, the electronic actuator 300 controls the braking force with which the pad presses the disk from the movement of the piston through position control.

In addition, the brake system 101 determines whether a failure has occurred and outputs information on the failure to a driver in a safety mode when the failure occurs. Specifically, when a failure occurs, the brake system 101 outputs a safety mode state through a indicator 200 so that the driver can recognize it.

The brake system 101 according to one embodiment of the present disclosure includes a control unit 100, as shown in FIG. 1.

The control unit 100 outputs the safety mode through the indicator 200. In addition, the control unit 100 controls a position of the electronic actuator 300 to provide braking force. Then, the control unit 100 compensates for the braking force based on the deceleration of the vehicle.

The case when the safety mode is output through the indicator 200 indicates a case where it is determined that force control of the electronic actuator 300 is not possible or that there is an error in the force control.

In the case where there is a reliability problem in the force control of the electronic actuator 300, the control unit 100 outputs the safety mode through the indicator 200. That is, the control unit 100 notifies the driver that the vehicle is in the safe mode and that needs to be inspected as soon as possible.

In this case, the control unit 100 controls the electronic actuator 300 through position control. Specifically, the control unit 100 provides braking force to the vehicle through position control of the electronic actuator 300.

Further, the control unit 100 compensates for the braking force based on the deceleration of the vehicle, so that the vehicle can be driven without significant loss in braking force even in the safe mode.

With such configurations, when the safety mode is output through the indicator 200, the brake system 101 according to one embodiment of the present disclosure can provide braking force through position control of the electronic actuator 300 due to a failure and compensate for the braking force based on the deceleration of the vehicle.

Accordingly, the brake system 101 can generate braking force while avoiding dangerous situations through position control of the electronic actuator 300 without a separate sensor.

Further, the control unit 100 of the brake system 101 according to one embodiment of the present disclosure may calculate a target deceleration based on information of the brake pedal 500.

The control unit 100 may calculate the target deceleration based on information of the brake pedal 500. Specifically, the driver may transmit his or her intention to brake through the brake pedal 500. The control unit 100 may calculate the target deceleration of the vehicle required by the driver based on information on the time when the brake pedal 500 is pressed and inclination of the brake pedal 500.

That is, the control unit 100 may calculate the target deceleration through braking based on information of the brake pedal 500.

In addition, a deceleration map 110 may be pre-stored in the control unit 100 of the brake system 101 according to one embodiment of the present disclosure.

The deceleration map 110 may have pre-stored information for controlling the electronic actuator 300 to output braking force corresponding to the calculated target deceleration. Specifically, the deceleration map 110 is matched with values for controlling the electronic actuator 300 corresponding to the target deceleration.

For example, the electronic actuator 300 includes a motor, and position information of the motor corresponding to the target deceleration may be pre-stored in the deceleration map 110. Specifically, the electronic actuator 300 may include an electro-mechanical brake (EMB) motor.

That is, the control unit 100 may control the position of the motor that moves the piston and provide braking force to generate deceleration.

In addition, in the brake system 101 according to one embodiment of the present disclosure, the control unit 100 may control the piston position through the electronic actuator 300.

The control unit 100 may control the piston position through the electronic actuator 300 to control the braking force with which the piston or pad presses a wheel.

Specifically, the control unit 100 may control the piston position through position control of the electronic actuator 300. That is, the control unit 100 may control the braking force by controlling a rotation speed of the electronic actuator 300 and controlling the position of the piston that expands and contracts thereby.

Accordingly, the control unit 100 can control the position of the piston through by controlling the rotation speed of the electronic actuator 300 rather than through force control.

That is, the position information of the piston according to the rotation of the electronic actuator 300 may be information known in advance through testing.

In addition, the control unit 100 of the brake system 101 according to one embodiment of the present disclosure may calculate current deceleration 120 of the vehicle according to the currently controlled electronic actuator 300, as shown in FIGS. 1 and 2.

The control unit 100 may control the electronic actuator 300 according to the deceleration map 110 and then calculate the current deceleration of the vehicle.

The control unit 100 may calculate the current deceleration of the vehicle after the electronic actuator 300 is operated to provide braking force.

Specifically, the control unit 100 may calculate the current deceleration of the vehicle after braking is performed under the control of the electronic actuator 300 based on the information received from a deceleration information unit 600.

In addition, the control unit 100 of the brake system 101 according to one embodiment of the present disclosure may compare the calculated current deceleration and the target deceleration.

By comparing the target deceleration and the current deceleration, the control unit 100 may determine whether correction to the braking force is required. Specifically, when the current deceleration is less than the target deceleration, the control unit 100 may determine that the braking force currently provided by the electronic actuator 300 requires correction. That is, when the current deceleration is less than the target deceleration, the control unit 100 may determine that the braking force needs to be corrected through readjustment of the electronic actuator 300.

Further, when the current deceleration exceeds the target deceleration, the control unit 100 may correct the braking force through readjustment of the electronic actuator 300.

In addition, the control unit 100 of the brake system 101 according to one embodiment of the present disclosure may compensate for the braking force by readjusting the position of the electronic actuator 300.

When the current deceleration is less than the target deceleration, the control unit 100 may readjust the position of the electronic actuator 300 to increase braking force.

Accordingly, the control unit 100 can effectively prevent an accident or the like that may occur due to insufficient braking force of the vehicle, which may be caused by the current deceleration less than the target deceleration.

Alternatively, when the current deceleration exceeds the target deceleration, the controller 100 may readjust the position of the electronic actuator 300 to reduce the braking force.

Accordingly, the control unit 100 can effectively prevent an accident or the like that may occur when the current deceleration exceeds the target deceleration and excessive braking force is applied to the vehicle.

In additional, the brake system 101 according to one embodiment of the present disclosure may further include a position detection unit 400.

The position detection unit 400 may detect position information of the electronic actuator 300 and transmit it to the control unit 100.

The position detection unit 400 may detect rotation information of the electronic actuator 300 and transmit it to the control unit 100. Accordingly, the control unit 100 can acquire the position information of the electronic actuator 300 based on the information of the position detection unit 400. That is, the control unit 100 can acquire the braking state information based on the information of the position detection unit 400.

As an example, the position detection unit 400 may detect a current position of the piston according to the control of the electronic actuator 300. Accordingly, the control unit 100 can acquire the current position of the piston based on the information detected by the position detection unit 400. That is, the control unit 100 can acquire the braking state information based on the information of the position detection unit 400.

Alternatively, the position detection unit 400 may detect the current position of the pad according to control of the electronic actuator 300. Accordingly, the control unit 100 may acquire the current position of the pad based on the information detected by the position detection unit 400. That is, the control unit 100 can acquire the braking state information based on the information of the position detection unit 400.

In addition, the brake system 101 according to one embodiment of the present disclosure can adjust braking force by controlling only the position control of the electronic actuator 300 when the safety mode is output through the indicator 200.

When the safety mode is output through the indicator 200, the brake system 101 may utilize only position control of the electronic actuator 300 to provide the braking force and compensate for the braking force. That is, when the safety mode is output through the indicator 200 due to low reliability in force control, the brake system 101 can adjust braking force and compensate for braking force by utilizing only position control of the electronic actuator 300.

In addition, the brake system 101 according to one embodiment of the present disclosure may further include an acceleration sensor 610.

The acceleration sensor 610 may detect a longitudinal acceleration of the vehicle and transmit it to the control unit 100. Specifically, the control unit 100 may calculate a current deceleration of the vehicle based on the longitudinal acceleration of the vehicle detected by the acceleration sensor 610.

In other words, the information detected by the acceleration sensor 610 may be used to calculate the current deceleration of the vehicle.

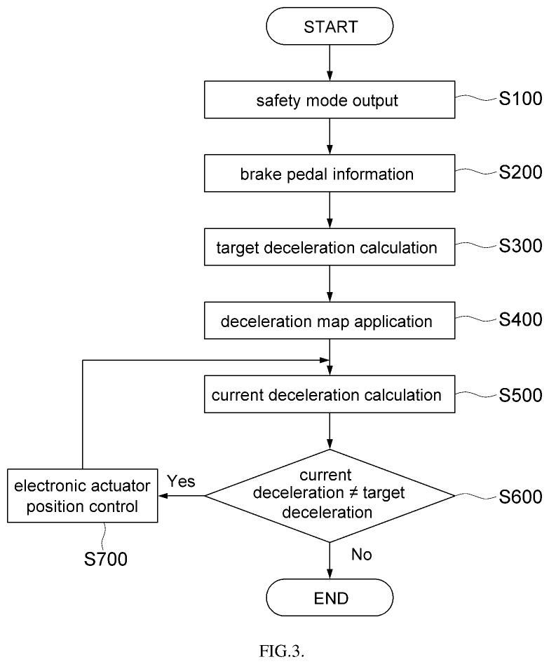

Hereinafter, the operation process of the brake system 101 according to one embodiment of the present disclosure will be described with reference to FIGS. 1 to 3.

The control unit 100 outputs the safety mode through the indicator 200 when a failure for force control of the electronic actuator 300 occurs (S100). Specifically, when force control of the electronic actuator 300 is impossible or there is doubt about its reliability, the control unit 100 may output the safety mode through the indicator 200 so that the driver can recognize it.

For example, when a force detection sensor for force control of the electronic actuator 300 malfunctions or an abnormality in the calculation of force values for the force control occurs, the control unit 100 may output the safe mode through the indicator 200.

The safe mode may be a limp home mode, for example. The control unit 100 may output this state information through the indicator 200 in the form of one or more of text, images, lamp emission, and audio information.

The control unit 100 receives information of the brake pedal 500 (S200).

The driver transmits his or her intention to brake through the brake pedal 500. The information of the brake pedal 500 may be transmitted to the control unit 100.

When the safety mode is output through the indicator 200, the control unit 100 calculates the target deceleration in consideration of the inclination of the brake pedal 500, the speed of the vehicle, and the operation timing of the brake pedal 500 (S300). Specifically, the control unit 100 may calculate the target deceleration based on information from the deceleration information unit 600 and information of the brake pedal 500.

For example, the deceleration information unit 600 may include a vehicle speed sensor 620 that detects the speed of the vehicle, an acceleration sensor 610 for detecting a longitudinal acceleration of the vehicle, and a wheel information detection sensor 630 that detects wheel information. Specifically, the wheel information detection sensor 630 can detect rotation information of a plurality of wheels.

The control unit 100 may receive vehicle speed information before the brake pedal 500 is operated through the deceleration information unit 600.

In addition, the control unit 100 controls the electronic actuator 300 to output braking force corresponding to target deceleration information from the deceleration map 110 (S400).

For example, in the deceleration map 110, mapped position information of the electronic actuator 300 preset according to the target deceleration information may be stored.

Alternatively, in the deceleration map 110, mapped position information of the piston preset according to the target deceleration information may be stored.

Alternatively, in the deceleration map 110, mapped position information of the pad preset according to the target deceleration information may be stored.

That is, the control unit 100 may check whether the electronic actuator 300, the piston, or the pad has been moved to a position matched to the deceleration map 110 based on the information detected by the position detection unit 400.

After controlling the electronic actuator 300, the control unit 100 calculates the current deceleration of the vehicle based on the information detected by the deceleration information unit 600 (S500).

The control unit 100 determines whether braking force compensation is needed (S600). Specifically, the control unit 100 may determine whether braking force compensation is necessary by comparing the current deceleration of the vehicle with the calculated target deceleration. When the current deceleration of the vehicle in the braking state under control of the electronic actuator 300 is less than the target deceleration, the control unit 100 may determine that compensation is needed to increase braking force by readjusting the position of the electronic actuator 300.

Alternatively, when the current deceleration of the vehicle in the braking state under control of the electronic actuator 300 exceeds the target deceleration, the control unit 100 may determine that compensation is needed to reduce the braking force by readjusting the position of the electronic actuator 300.

Specifically, braking force information that increases or decreases depending on the rotation of the electronic actuator 300 may be pre-stored in the control unit 100.

That is, the control unit 100 may compare whether the current deceleration of the vehicle matches the calculated target deceleration and perform braking force compensation when the current deceleration of the vehicle is different from the calculated target deceleration.

In other words, the control unit 100 controls the electronic actuator 300 to compensate for the braking force so that the current deceleration of the vehicle becomes the same as the calculated target deceleration (S700).

With such configurations, the brake system 101 according to one embodiment of the present disclosure can control the position of the electronic actuator 300 to provide braking force and compensate for the braking force when the safety mode is output due to an error in the force control of the electronic actuator 300 that moves the piston

Accordingly, the brake system 101 can effectively provide braking force even in a situation where the safety mode is output through the indicator 200 and effectively prevent an accident due to insufficient braking force.

Further, the brake system 101 can effectively provide braking force without a separate force sensor.

Although the embodiments of the present disclosure have been described with reference to the accompanying drawings, it will be understood by those skilled in the art to which the present disclosure pertains that the present disclosure may be practiced in other specific forms without changing its technical ideas or essential features.

Accordingly, the embodiments described above should be understood as exemplary and non-limiting in all respects, and the scope of the present disclosure is indicated by the following claims, and all changes or modifications derived from the meaning and scope of the patent claims, and the equivalent concept should be construed as falling within the scope of the present disclosure.

### DESCRIPTION OF REFERENCE NUMERALS

100: control unit 101: brake system
110: deceleration map 200: indicator
300: electronic actuator 400: position detection unit
610: acceleration sensor 500: brake pedal

What is claimed is:

1. A brake system which controls a piston through force control and position control of an electronic actuator to press a disk and provide braking force and is installed in a vehicle to determine whether a failure has occurred and output a safety mode through an indicator when a failure occurs, the brake system comprising:
a control unit that controls a position of the electronic actuator to provide braking force and compensates the braking force based on a deceleration of the vehicle when the safety mode is output through the indicator.

2. The brake system of claim 1, wherein the control unit calculates target deceleration based on information of a brake pedal.

3. The brake system of claim 2, wherein a deceleration map for controlling the electronic actuator to output a braking force corresponding to the calculated target deceleration is pre-stored in the control unit.

4. The brake system of claim 3, wherein the control unit controls a position of the piston through the electronic actuator based on the deceleration map.

5. The brake system of claim 4, wherein the control unit calculates a current deceleration of the vehicle according to the controlled electronic actuator.

6. The brake system of claim 5, wherein the control unit compensates for braking force by readjusting the position of the piston through the electronic actuator based on the calculated current deceleration information of the vehicle.

7. The brake system of claim 4, further comprising:
a position detection unit that transmits position information of the electronic actuator to the control unit.

8. The brake system of claim 1, wherein the control unit controls only the position control of the electronic actuator to adjust the braking force when the safety mode is output through the indicator.

9. The brake system of claim 5, further comprising:
an acceleration sensor for detecting a longitudinal acceleration of the vehicle and transmits the detected longitudinal acceleration to the control unit.

10. A brake system which controls a piston through force control and position control of an electronic actuator to press a disk and provide braking force, and is installed in a vehicle to operate in a safety mode when a failure occurs for force control of the electronic actuator, the brake system comprising:
an indicator that outputs the safe mode;
a brake pedal that transmits a driver's intention to brake; and
a control unit that compensates for the braking force by controlling the position of the electronic actuator based on information of the brake pedal when the safety mode is output through the indicator.

11. The brake system of claim 10, wherein the control unit calculates target deceleration based on the information of the brake pedal and a speed of the vehicle.

12. The brake system of claim 11, wherein the control unit controls the electronic actuator based on position information of the electronic actuator preset according to target deceleration information.

13. The brake system of claim 11, wherein the control unit controls the electronic actuator based on position information of the piston preset according to target deceleration information.

14. The brake system of claim 11, wherein the control unit controls the electronic actuator based on position information of a pad preset according to target deceleration information.

15. The brake system of claim 11, wherein a deceleration map for controlling the electronic actuator to output a braking force corresponding to the target deceleration information is pre-stored in the control unit.

16. The brake system of claim 15, wherein the control unit controls the electronic actuator based on the deceleration map and then calculates a current deceleration of the vehicle.

17. The brake system of claim 16, wherein the control unit compares the current deceleration of the vehicle with the calculated target deceleration to determine whether compensation for the braking force is needed.

18. The brake system of claim 17, wherein the control unit controls the electronic actuator to compensate for the braking force when the current deceleration of the vehicle is different from the calculated target deceleration.

19. The brake system of claim 10, wherein the electronic actuator includes a motor of which rotation is controlled by the control unit.

20. The brake system of claim 16, wherein the control unit calculates the current deceleration of the vehicle based on any one of an acceleration sensor that detects a longitudinal acceleration of the vehicle, current speed information of the vehicle, or information about wheels of the vehicle.
